(19) United States
(12) Patent Application Publication
(10) Pub. No.: US 2026/0339262 A1
(43) Pub. Date: Oct. 29, 2026

(54) BLADE SUPPORTING DEVICE WITH MOVABLE BLADE HOLDER

(71) Applicant: HEWLETT-PACKARD DEVELOPMENT COMPANY, L.P., Spring, TX (US)

(72) Inventors: Satoru Hori, Kanagawa (JP); Kensuke Nakajima, Kanagawa (JP)

(73) Assignee: HEWLETT-PACKARD DEVELOPMENT COMPANY, L.P., Spring, TX (US)

(21) Appl. No.: 19/107,016

(22) PCT Filed: Jan. 3, 2023
(86) PCT No.: PCT/US2023/010060

§ 371 Date: Feb. 26, 2025

(30) Foreign Application Priority Data
Sep. 29, 2022 (JP) 2022-156712

(51) Int. Cl. G03G 21/00; G03G 15/08; G03G 21/16

(52) U.S. Cl. CPC G03G 21/0029; G03G 15/0812; G03G 21/169; G03G 2215/1661

(57) ABSTRACT

A blade supporting device according to an aspect includes a housing; a blade holder supported by the housing, the blade holder including a first member supporting a blade and a second member movable between a closed position and an open position, wherein the blade is sandwiched between the first member and the second member at the closed position, and the second member is separated from the first member at the open position; and a locking device to lock the second member to keep the position of the blade with respect to the first member.

### CROSS-REFERENCE TO RELATED PATENT APPLICATIONS

This application claims priority to Japan Patent Application No. 2022-156712, filed on Sep. 29, 2022, the entirety of which is incorporated by reference herein.

### BACKGROUND

An image forming system includes a conveying device which conveys a printing medium, a photoreceptor on which an electrostatic latent image is to be formed, a developing device which develops an electrostatic latent image, a transfer device which transfers a toner image to a printing medium, a fixing device which fixes a toner image to a printing medium, a discharge device which discharges a printing medium, and a cleaning device which removes a toner remaining on the transfer device.

### BRIEF DESCRIPTION OF DRAWINGS

FIG. 1 is a schematic view of an example image forming apparatus that can be used to implement various examples disclosed herein.

FIG. 2 is a perspective view of an example blade supporting device.

FIG. 3 is a perspective view of an example blade supporting device when viewed from the rear side.

FIG. 4 is a side view of an example blade supporting device.

FIG. 5 is a cross-sectional view of an example blade supporting device.

FIG. 6 is a cross-sectional view showing an example operation of a blade holder.

FIG. 7 is a view showing an example operation of an opening and closing mechanism.

FIG. 8 is a perspective view showing a first sliding frame.

FIG. 9 is a cross-sectional view of the first sliding frame taken along the line A-A of FIG. 8.

FIG. 10 is an enlarged perspective view showing the periphery of an engagement portion.

FIG. 11 is a perspective view showing a second sliding frame.

FIG. 12 is a view showing an example procedure of replacing a blade.

FIG. 13 is a view showing an example procedure following FIG. 12.

FIG. 14 is a view showing an example procedure following FIG. 13.

FIG. 15 is a view illustrating an example movement of an engagement portion.

FIG. 16 is a view illustrating an example procedure following FIG. 14.

FIG. 17 is a perspective view showing a second sliding frame inserted into a housing.

FIG. 18 is a view illustrating an example procedure following FIG. 16.

FIG. 19 is a view illustrating an example procedure following FIG. 18.

FIG. 20 is a cross-sectional view showing a modified example of the blade supporting device.

FIG. 21 is a cross-sectional view showing a modified example of the blade supporting device.

### DETAILED DESCRIPTION

Hereinafter, an image forming apparatus including an example blade supporting device is described with reference to the drawings. Additionally, in the description based on the drawings, the same elements or elements having the same function are denoted by the same reference numerals, and overlapping descriptions may be omitted. The drawings may be partially simplified or exaggerated for ease of understanding, and dimensional ratios, angles, and the like are not limited to those described in the drawings.

The image forming apparatus according to the present disclosure is, for example, an image forming apparatus such as a printer. The image forming apparatus includes a conveying body that conveys a toner. The image forming apparatus includes a blade supporting device that supports a blade. The blade supporting device includes a housing and a blade holder, wherein the blade holder is to be at a closed position and an open position. The blade is fixed in the closed position, and the blade is released in the open position. In the image forming apparatus, the blade can be replaced individually from the blade supporting device by operating the blade holder between the closed position and the open position. Thus, the maintenance cost of the image forming apparatus can be reduced. In the following description, the blade supporting device is a cleaning device which supports a blade, the blade for removing a toner remaining on an intermediate transfer belt that is to transfer a toner to a sheet. The blade supporting device may be a regulating device for a developing roller or a cleaning device for a photosensitive drum. However, the blade supporting device is not limited to said devices, and the blade supporting device may be used for various types of devices in printing devices.

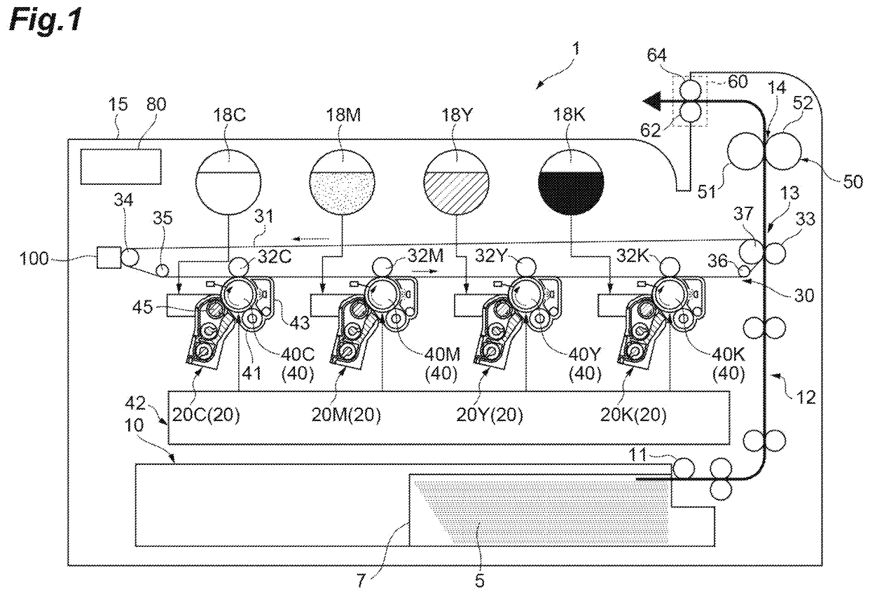

FIG. 1 is a view schematically showing an example image forming apparatus. An image forming apparatus 1 shown in FIG. 1 is an apparatus that forms a color image by using colors of cyan, magenta, yellow, and black. The image forming apparatus 1 includes a conveying device 10 which conveys a sheet 5 corresponding to a printing medium, a plurality of developing devices 20C, 20M, 20Y, and 20K (hereinafter, referred to as a “developing device 20” when it is not necessary to distinguish individual elements) which develop an electrostatic latent image, a transfer device 30 which transfers a toner image of each color to the sheet 5, a plurality of photoreceptors 40C, 40M, 40Y, and 40K (hereinafter, referred to as a “photoreceptor 40” when it is not necessary to distinguish individual elements) that have surfaces on which an electrostatic latent image is to be formed, a fixing device 50 which fixes a layered toner image to the sheet 5, a discharge device 60 which discharges the sheet 5, and a blade supporting device 100 which removes a toner from the transfer device 30. The conveying device 10, the developing device 20, the transfer device 30, the photoreceptor 40, the fixing device 50, the discharge device 60, and the blade supporting device 100 are accommodated inside the casing 15 of the image forming apparatus 1.

The conveying device 10 conveys the sheet 5 corresponding to a print medium on which an image is to be formed on a conveying path 12. The sheet 5 is accommodated to be stacked in a cassette 7. The sheet 5 is picked up and conveyed by a feeding roller 11. The conveying device 10 conveys the sheet 5 to a transfer region 13 through the conveying path 12 when the toner image to be transferred to the sheet 5 reaches the transfer region 13.

The developing devices 20C, 20M, 20Y, and 20K are provided for respective colors. Each developing device 20 includes a developing roller 45 that carries a toner on the photoreceptor 40. In the developing device 20, a two-component developer, including a toner and a carrier, is used as the developer. That is, in the developing device 20, the toner and the carrier are adjusted to have a desired mixing ratio, and further mixed and agitated to uniformly disperse the toner and provide the developer with the optimum amount of charge. This developer is carried by the developing roller 45. When the developer is conveyed to a developing region facing the photoreceptor 40 by the rotation of the developing roller 45, the toner contained in the developer and carried by the developing roller 45 is transferred to the electrostatic latent image formed on the peripheral surface of the photoreceptor 40 so that the electrostatic latent image is developed.

The transfer device 30 conveys the toner image formed by the developing device 20 to the transfer region 13 in which the toner image is transferred to the sheet 5. The transfer device 30 includes an intermediate transfer belt 31 to which the toner image is transferred from the photoreceptor 40, a tension roller 34 which stretches the intermediate transfer belt 31, idler rollers 35 and 36, a drive roller 37 which drives the intermediate transfer belt 31, first transfer rollers 32C, 32M, 32Y, and 32K which respectively sandwich the intermediate transfer belt 31 together with the photoreceptors 40C, 40M, 40Y, and 40K, and a second transfer roller 33 which sandwiches the intermediate transfer belt 31 together with the drive roller 37. The intermediate transfer belt 31 is a rotatable carrier that carries the toner image.

The photoreceptors 40C, 40M, 40Y, and 40K are also called electrostatic latent image carriers, photoreceptor drums, and the like. The photoreceptors 40C, 40M, 40Y, and 40K are provided for respective colors. Each photoreceptor 40 is provided along the moving direction of the intermediate transfer belt 31. The developing device 20, a charging device 41, an exposure unit 42, and the cleaning device 43 are provided on the periphery of the photoreceptor 40.

The charging device 41 may be, for example, a charging roller that comes the photoreceptor 40 and uniformly charges the surface of the photoreceptor 40 according to a predetermined potential. The exposure unit 42 exposes the surface of the photoreceptor 40 charged by the charging device 41 according to the image to be formed on the sheet 5. Accordingly, the potential of a portion exposed by the exposure unit 42 on the surface of the photoreceptor 40 changes so that the electrostatic latent image is formed. The developing devices 20C, 20M, 20Y, and 20K develop the electrostatic latent images formed on the photoreceptors 40 by the toners supplied from toner tanks 18C, 18M, 18Y, and 18K and provided to face respective developing devices 20 to form the toner image. The toner tanks 18C, 18M, 18Y, and 18K are respectively filled with cyan, magenta, yellow, and black toners. The cleaning device 43 collects the toner remaining on the photoreceptor 40 after the toner image formed on the photoreceptor 40 is transferred to the intermediate transfer belt 31.

The fixing device 50 fixes the toner image, transferred from the intermediate transfer belt 31 to the sheet 5, by passing the sheet 5 through a fixing nip region 14. The fixing device 50 includes a heating roller 51 and a pressing roller 52 which contacts and presses the outer peripheral surface of the heating roller 51. The fixing nip region 14 is formed between the heating roller 51 and the pressing roller 52. When the sheet 5 passes through the fixing nip region 14, the toner image is melted and fixed to the sheet 5.

The discharge device 60 includes discharge rollers 62 and 64, which discharge the sheet 5 to the outside of the apparatus, the sheet 5 including the toner image fixed by the fixing device 50. The blade supporting device 100 removes the toner remaining on the intermediate transfer belt 31 after the layered toner image formed on the intermediate transfer belt 31 is transferred to the sheet 5.

The image forming apparatus 1 further includes a control device 80. The control device 80 may be a computer including a processor, a storage unit, an input unit, a display device, and the like and has a function of controlling the overall operation of the image forming apparatus 1. The storage unit of the control device 80 may store a control program for controlling the image forming apparatus 1 to perform various processes, and the processor of the control device 80 may execute the control program.

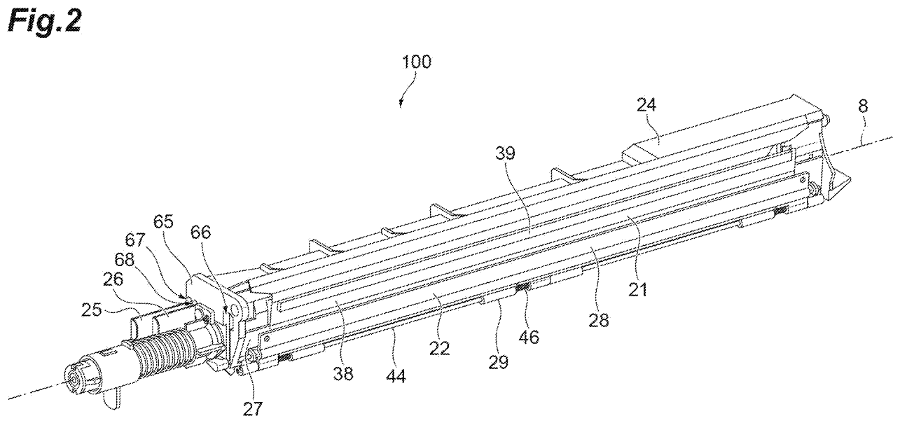

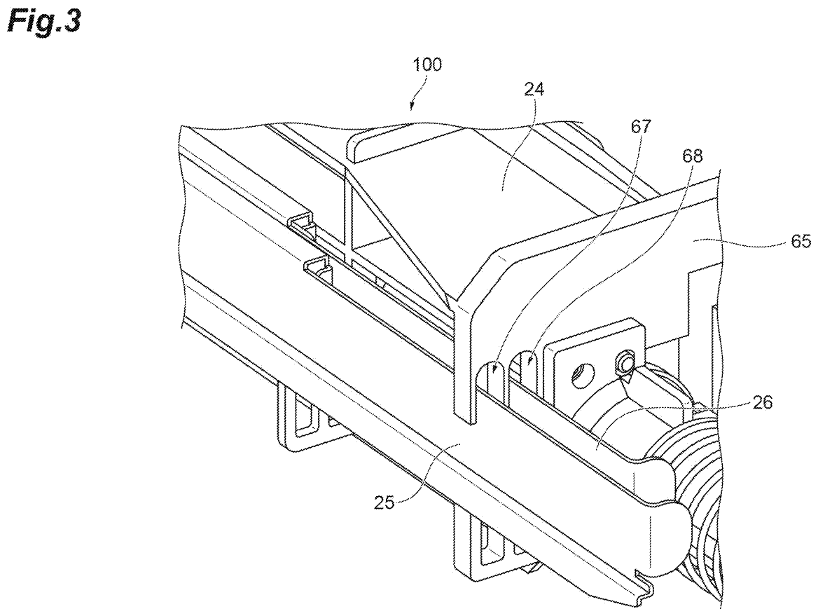

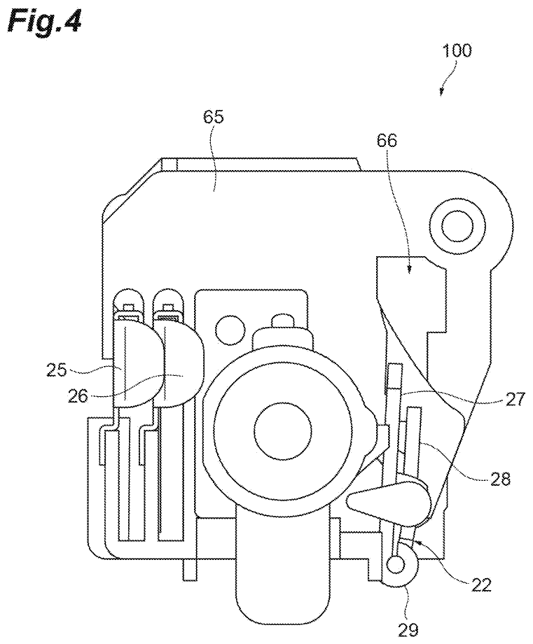

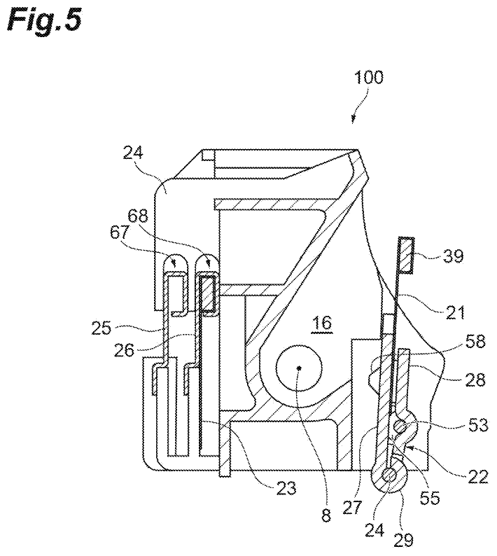

Hereinafter, the blade supporting device 100 is described in detail. The blade supporting device 100 is provided adjacent to the intermediate transfer belt 31 and collects remaining toner (i.e., the toner not transferred onto the sheet 5) from the intermediate transfer belt 31. FIG. 2 is a perspective view of an example blade supporting device 100. FIG. 3 is a perspective view of an example blade supporting device 100 when viewed from the rear side. FIG. 4 is a side view of an example blade supporting device 100. FIG. 5 is a cross-sectional view of an example blade supporting device 100, showing a plane perpendicular to the axis 8.

The blade supporting device 100 includes a blade holder 22 which supports a blade 21 and a housing 24 which supports the blade holder 22. The blade 21 may be, for example, a scraper to scrape off the toner remaining on the intermediate transfer belt 31. As shown in FIG. 2, the blade 21 includes a plate portion 38 and a sliding portion 39.

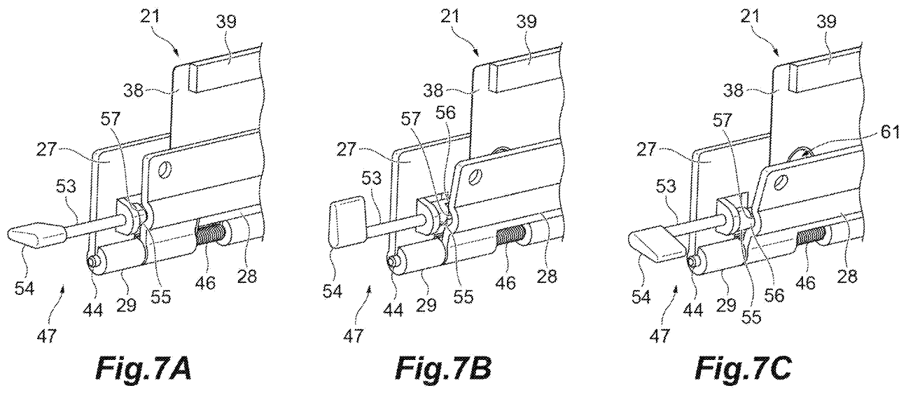

The plate portion 38 is a metallic thin plate extending in the longitudinal direction. The longitudinal direction is a direction parallel to the axis 8 of the blade supporting device 100. A first opening 61 is formed on the plate portion 38 (see FIG. 7C). The first opening 61 may be more than one opening. The sliding portion 39 is fixed to a portion of the plate portion 38. For example, the sliding portion 39 may be formed of an elastic material such as rubber or resin, and the sliding portion 39 may extend in the longitudinal direction along the upper end of the plate portion 38. When printing on the sheet 5, the sliding portion 39 contacts the intermediate transfer belt 31 to scrape off the toner from the intermediate transfer belt 31.

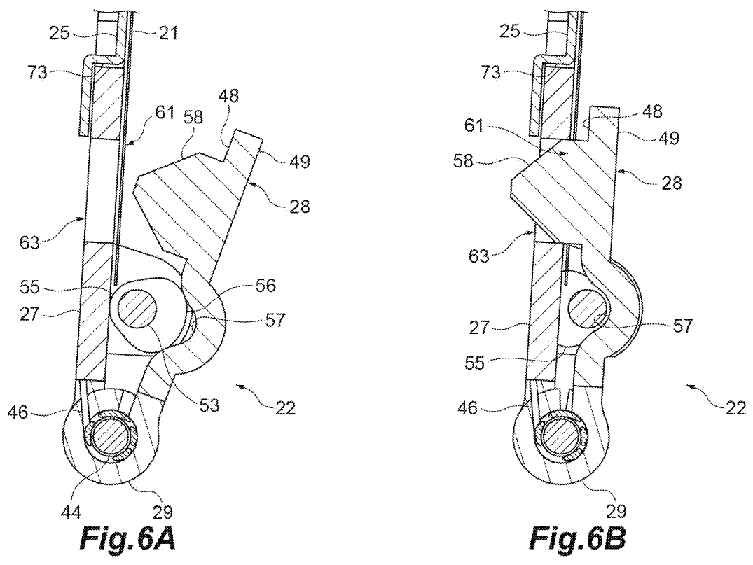

The blade holder 22 extends in the longitudinal direction. The blade holder 22 is to be at a closed position and an open position, wherein the blade 21 is fixed to the blade holder 22 in the closed position, and the blade 21 is released from the blade holder 22 in the open position. As shown in FIGS. 2, 4, and 5, the blade holder 22 includes a first member 27, a second member 28, and a hinge 29. The first member 27 is a metallic plate fixed to the housing 24, the first member 27 extending in the longitudinal direction. A second opening 63 penetrates the first member 27 in the thickness direction and is formed on the first member 27 (see FIG. 6A). The second opening 63 may be more than one opening. When the blade 21 is supported by the blade holder 22, the second opening 63 of the first member 27 is aligned to the first opening 61 of the blade 21.

The second member 28 may be, for example, a metallic plate extending in the longitudinal direction. The second member 28 is movable between a closed position and an open position, wherein the blade 21 is sandwiched between the first member 27 and the second member 28 in the closed position, and the blade is separated from the first member 27 in the open position. The hinge 29 connects the first member 27 and the second member 28 so that the second member 28 is rotatable around a rotation shaft 44 that extends in the longitudinal direction. Since the first member 27 and the second member 28 are connected through the hinge 29, the second member 28 is movable between the closed position and the open position.

FIG. 6A is a cross-sectional view showing the blade holder 22 at the open position, and FIG. 6B is a cross-sectional view showing the blade holder 22 at the closed position. As shown in FIG. 6B, when the second member 28 is at the closed position, the blade 21 is sandwiched between the first member 27 and the second member 28. Accordingly, the blade 21 is held between the first member 27 and the second member. On the other hand, as shown in FIG. 6A, when the second member 28 is at the open position, the second member 28 is at a position separated from the first member 27. Thus, the blade 21 is released with respect to the blade holder 22, and the blade 21 can be attached to and detached from the blade holder 22.

The second member 28 includes an inner surface 48 located on the side of the first member 27 and an outer surface 49 located on the side opposite to the inner surface 48. As shown in FIG. 6B, when the second member 28 is at the closed position, the inner surface 48 of the second member 28 faces the first member 27. A concave portion 57 is recessed toward the outer surface and is formed on the inner surface 48 of the second member 28. The concave portion 57 extends in the longitudinal direction.

Further, a pin 58 protrudes toward the first member 27, and the pin 58 is provided on the inner surface 48 of the second member 28. As shown in FIG. 6A, when the second member 28 is at the open position, the pin 58 is separated from the blade 21 and the first member 27. As shown in FIG. 6B, when the second member 28 moves toward the closed position, the pin 58 is inserted into the second opening 63 of the first member 27 through the first opening 61 of the blade 21. The pin 58 is inserted into the first opening 61 of the blade 21 and the second opening 63 of the first member 27 so that the blade 21 is fixed in the longitudinal direction.

The blade supporting device 100 further includes a locking device to keep the position of the blade 21 with respect to the first member 27 by locking the second member 28 when the first member 27 and the second member 28 are at the closed position. The locking device may be or include a spring, a magnet, or other locking components to keep the position of the blade 21, but the locking device is not limited to said components. The locking device may be combined with the second member 28, which is movable. The movement of the second member 28 is restricted in the locked state, and the second member 28 is allowed to move between the open position and the closed position when the locked state is released. The blade can be replaced when the locked state is released.

A spring 46, provided in the hinge 29, urges the second member 28 with respect to the first member 27. The spring 46 may function as a locking device to keep the position of the blade 21 with respect to the first member 27 by locking the second member 28. In the locked state, the second member 28 is held at the closed position when an external force is not applied to the second member 28. For example, the spring 46 may be provided in the rotation shaft 44 of the hinge 29, and the spring 46 urges the second member 28 toward the first member 27 to fix the second member 28 at the closed position.

The blade supporting device 100 further includes an opening and closing mechanism 47, which moves the second member 28 between the closed position and the open position. FIGS. 7A to 7C are views showing an operation of the opening and closing mechanism 47. As shown in FIG. 7A, the opening and closing mechanism 47 includes a camshaft 53, a lever 54, and a cam 55. The camshaft 53 is disposed between the first member 27 and the second member 28, extending in the longitudinal direction parallel to the rotation shaft 44, and is supported by the first member 27 to be rotatable around the axis.

The lever 54 is connected to the cam 55 through the camshaft 53. More specifically, the lever 54 is fixed to the longitudinal end portion of the camshaft 53 and extends in a direction perpendicular to the axis of the camshaft 53. By operating the lever 54, the camshaft 53 rotates around the axis. The cam 55 is to be rotatable between the first member 27 and the second member 28 so that the second member 28 rotates about the rotation shaft 44 of the hinge 29. The cam 55 rotates in accordance with the rotation of the camshaft 53.

The cam 55 has a substantially cylindrical shape or a substantially disk shape and is fixed to the camshaft 53 at a position eccentric to the center point. That is, the cam 55 eccentrically rotates between the first member 27 and the second member 28 in accordance with the rotation of the camshaft 53. A cam surface 56, formed on the cam 55, protrudes in a direction perpendicular to the axial direction of the camshaft 53.

As shown in FIG. 7A, when the lever 54 is operated to rotate the camshaft 53 in a first direction while the second member 28 is at the closed position, the cam 55 rotates together with the camshaft 53 so that the cam surface 56 contacts the second member 28. When the camshaft 53 rotates further in the first direction, the second member 28 is pressed by the cam surface 56, and the second member 28 rotates such that the second member 28 moves away from the first member 27 against the urging force of the spring 46 as shown in FIG. 7B.

When the camshaft 53 rotates further in the first direction, the second member 28 rotates such that the second member 28 moves away from the first member 27 and is located at the open position, and the cam surface 56 is fitted to the concave portion 57 of the second member 28 as shown in FIG. 7C. Since the cam surface 56 is fitted to the concave portion 57, the second member 28 is fixed at the open position.

When the second member 28 is moved from the open position to the closed position, the lever 54 is operated to rotate the camshaft 53 in a second direction (which is opposite to the first direction). When the camshaft 53 rotates in the second direction, the fitting between the cam surface 56 and the concave portion 57 is released as shown in FIG. 7B. Then, the second member 28 rotates such that the second member 28 moves toward the first member 27 by the urging force of the spring 46, and the second member 28 is disposed at the closed position as shown in FIG. 7A. As shown in FIG. 6B, the pin 58 of the second member 28 is inserted into the second opening 63 of the first member 27 through the first opening 61 of the blade 21.

The housing 24 is disposed adjacent to the blade holder 22 and supports the blade holder 22. As shown in FIG. 5, the housing 24 defines a collection chamber 16, which stores the toner removed from the intermediate transfer belt 31 by the blade 21. A conveying device such as a screw conveyor is provided in the collection chamber 16, and the toner collected in the collection chamber 16 may be conveyed to the outside of the housing 24 by the operation of the conveying device.

As shown in FIG. 2, the housing 24 includes a longitudinal end portion 65. The longitudinal end portion 65 may have, for example, a plate shape and may extend in a direction perpendicular to the axis 8. A third opening 66 is formed at the longitudinal end portion 65. Through the third opening 66, the blade 21 is pulled out from the housing 24 in the longitudinal direction. The third opening 66 may be a slit-like through-hole corresponding to the shape of the blade 21 and may be formed at the longitudinal end portion 65 to be aligned with the blade 21, wherein the blade 21 is supported by the blade holder 22 in the longitudinal direction of the blade holder 22.

As shown in FIG. 3, a first accommodation space 67 and a second accommodation space 68 are formed in the housing 24. The first accommodation space 67 and the second accommodation space 68 accommodate a first sliding frame 25 and a second sliding frame 26, respectively. The first accommodation space 67 and the second accommodation space 68 are formed at a position adjacent to the blade holder 22. The first sliding frame 25 and the second sliding frame 26 have a thin plate shape extending in the longitudinal direction. The first sliding frame 25 and the second sliding frame 26 have a dimension such that the first sliding frame 25 and the second sliding frame 26 can be inserted into the housing 24 through the third opening 66 of the housing 24.

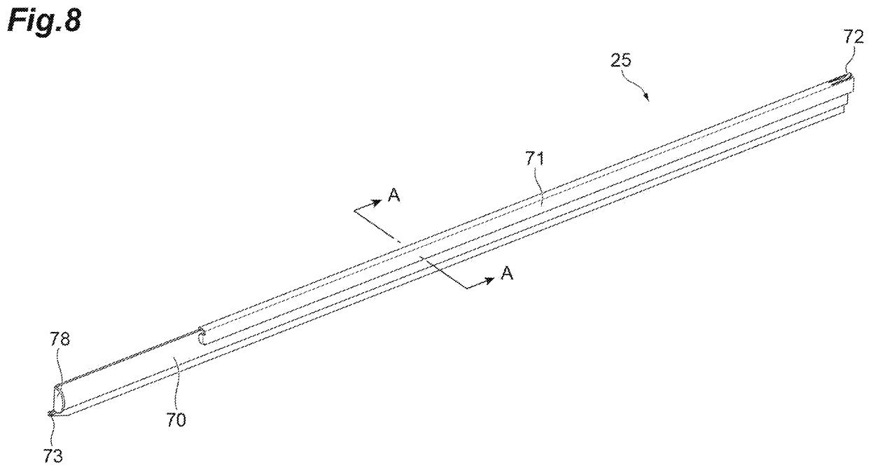

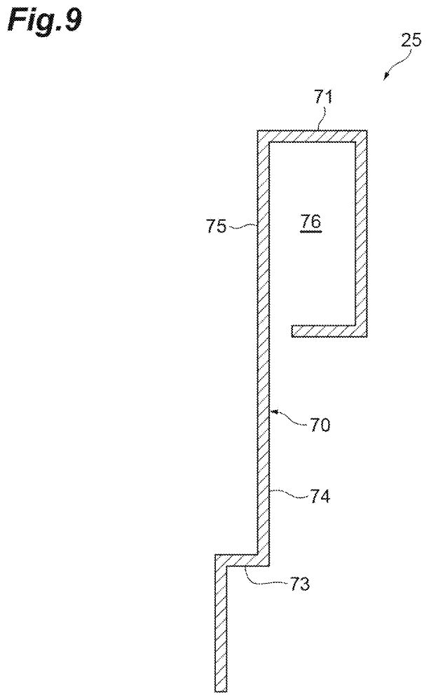

The first sliding frame 25 engages with the blade 21 supported by the blade holder 22 and is to pull out the blade 21 from the housing 24. FIG. 8 is a perspective view showing an example first sliding frame 25. FIG. 9 is a cross-sectional view of the first sliding frame 25 taken along the line A-A of FIG. 8.

As shown in FIG. 8, the first sliding frame 25 includes a base plate 70 which extends in the longitudinal direction, a cover 71 which accommodates at least a part of the blade 21, an engagement portion 72 which engages the blade 21 with the cover 71, and a guide rail 73 which guides the first sliding frame 25 in the longitudinal direction.

As shown in FIG. 9, the base plate 70 includes a first surface 74 and a second surface 75 on the side opposite to the first surface 74. The cover 71 is provided on the first surface 74 of the base plate 70 and extends in the longitudinal direction along the base plate 70. The cover 71 has a substantially U-shaped cross-section and has an internal space 76, which is to accommodate a part of the blade 21. A gap is formed between the base plate 70 and the end portion of the cover 71, and when the blade 21 is inserted through the gap, the sliding portion 39 of the blade 21 is accommodated in the internal space 76 of the cover 71. When the sliding portion 39 of the blade 21 is accommodated in the internal space 76 of the cover 71, the first surface 74 of the base plate 70 faces the plate portion 38 of the blade 21.

The guide rail 73 is provided in the second surface 75 of the base plate 70. As shown in FIG. 9, the guide rail 73 has a substantially L-shaped cross section. Specifically, the guide rail 73 includes a first portion extending substantially perpendicular to the base plate 70 and a second portion, which is bent from the first portion and extends substantially in parallel to the base plate 70. As shown in FIG. 6A, when the first sliding frame 25 is inserted into the housing 24 through the third opening 66 of the housing 24, the guide rail 73 is placed on the upper end surface of the first member 27 of the blade holder 22 and slides along the first member 27. The first sliding frame 25 is guided in the longitudinal direction by sliding the guide rail 73.

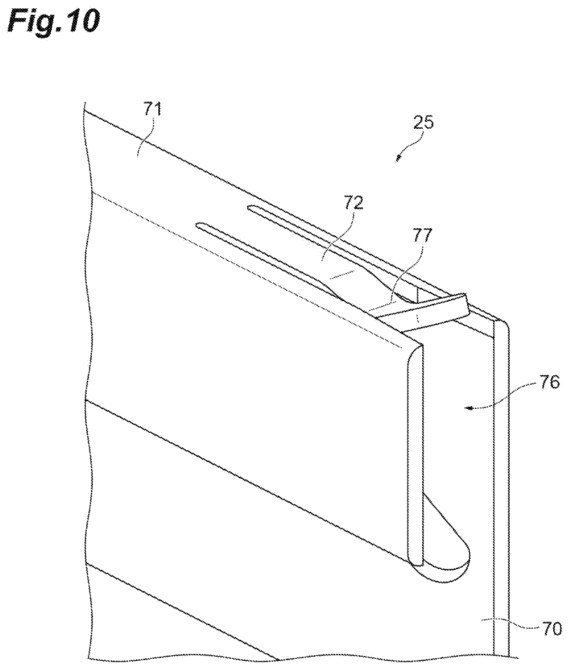

The engagement portion 72 is disposed at the longitudinal end portion of the cover 71 and extends in the longitudinal direction from the longitudinal end portion of the cover 71 on the same surface as the upper end surface of the cover 71. FIG. 10 is an enlarged perspective view of the periphery of the engagement portion 72. The engagement portion 72 includes a protrusion portion 77, which protrudes toward the internal space 76 of the cover 71. The protrusion portion 77 is curved in a convex shape toward the internal space 76. As described later, the engagement portion 72 prevents the blade 21 accommodated in the internal space 76 of the cover 71 from slipping out from the longitudinal end portion of the cover 71.

As shown in FIG. 8, the first sliding frame 25 may further include a grip portion 78, which may be used as a handle. The grip portion 78 is provided at the end portion of the base plate 70 on the side opposite to the engagement portion 72 in the longitudinal direction and extends in a direction substantially perpendicular to the base plate 70. By pinching the grip portion 78, the first sliding frame 25 can be easily pulled out from the housing 24. As shown in FIG. 5, the first sliding frame 25 is accommodated in the first accommodation space 67 while not holding the blade 21.

The second sliding frame 26 supports a spare blade 23. The spare blade 23 is a replacement part that may be replaced with the blade 21. The spare blade 23 has the same configuration as that of the blade 21. Thus, the spare blade 23 includes the metallic plate portion 38 provided with a first opening 61 and the sliding portion 39 which is formed of an elastic material such as rubber or resin and contacts the intermediate transfer belt 31.

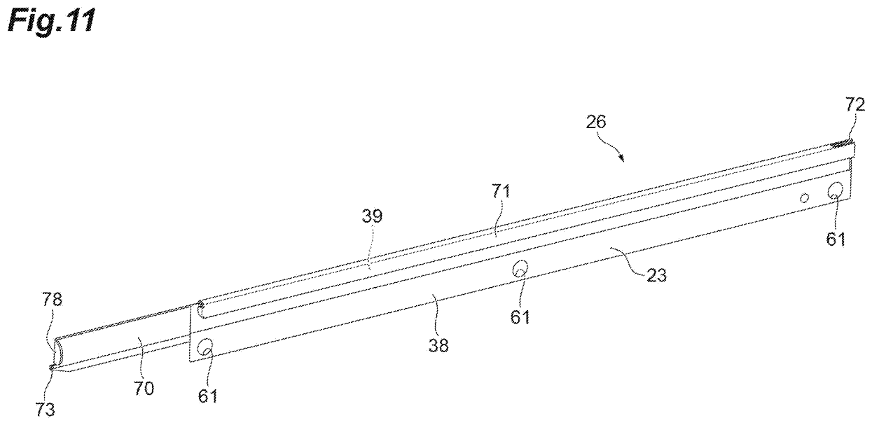

The second sliding frame 26 is inserted into the housing 24 through the third opening 66 in order to dispose the spare blade 23 inside the blade holder 22. The second sliding frame 26 has the same configuration as that of the first sliding frame. That is, as shown in FIG. 11, the second sliding frame 26 includes a base plate 70 extending in the longitudinal direction, a cover 71 which accommodates at least a part of the spare blade 23, an engagement portion 72 which engages the spare blade 23 with the cover 71, a guide rail 73 which guides the first sliding frame 25 in the longitudinal direction, and the grip portion 78 which may be used as a handle. As shown in FIG. 5, the second sliding frame 26 is accommodated in the second accommodation space 68 while holding the spare blade 23.

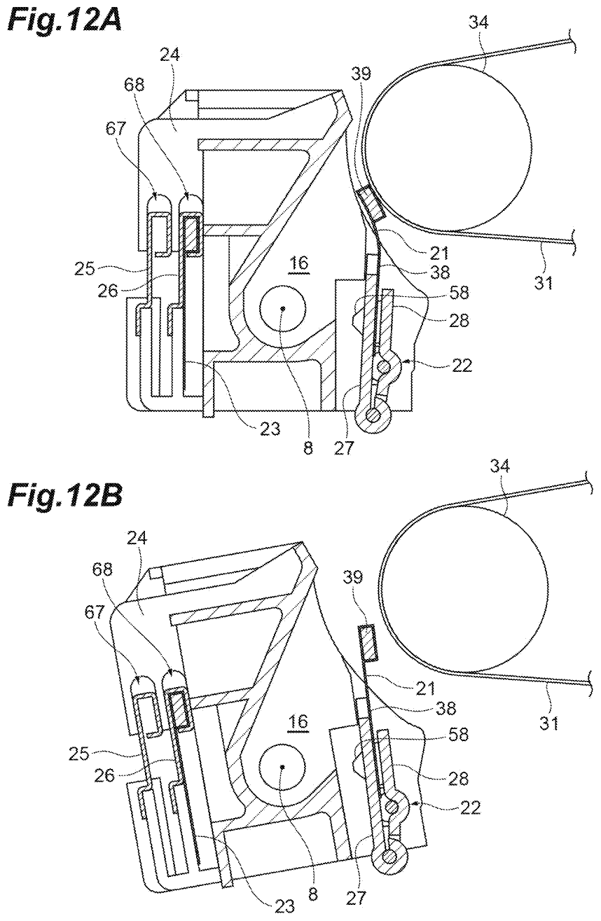

Hereinafter, a procedure for replacing the blade 21 with the spare blade 23 is described. As shown in FIG. 12A, the second member 28 of the blade holder 22 is disposed at the closed position, and the blade holder 22 holds the blade 21 when printing on the sheet 5 with the image forming apparatus 1. The sliding portion 39 of the blade 21 contacts the rotating intermediate transfer belt 31 at a predetermined pressure so that the toner is removed from the intermediate transfer belt 31. The toner removed from the intermediate transfer belt 31 is collected in the collection chamber 16 of the housing 24. The toner collected in the collection chamber 16 is conveyed to the outside of the housing 24 by, for example, a conveying device such as a screw conveyor.

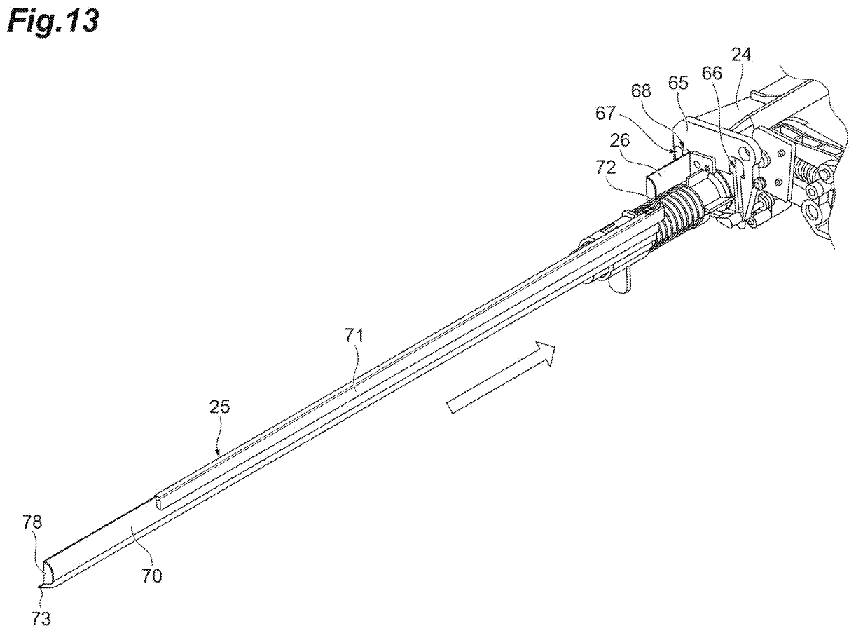

When the usage time of the blade 21 reaches a predetermined time, the used blade 21 is replaced with the spare blade 23 by a user or an operator. When replacing the blade 21, as shown in FIG. 12B, the housing 24 rotates around the axis 8, and the blade 21 is disposed at a position separate from the intermediate transfer belt 31. Next, the first sliding frame 25 is pulled out from the first accommodation space 67, and as shown in FIG. 13, the first sliding frame 25 is inserted into the housing 24 from the third opening 66 formed at the longitudinal end portion 65 of the housing 24. At this time, the guide rail 73 of the first sliding frame 25 slides along the upper end surface of the first member 27 of the blade holder 22 so that the first sliding frame 25 is guided in the longitudinal direction.

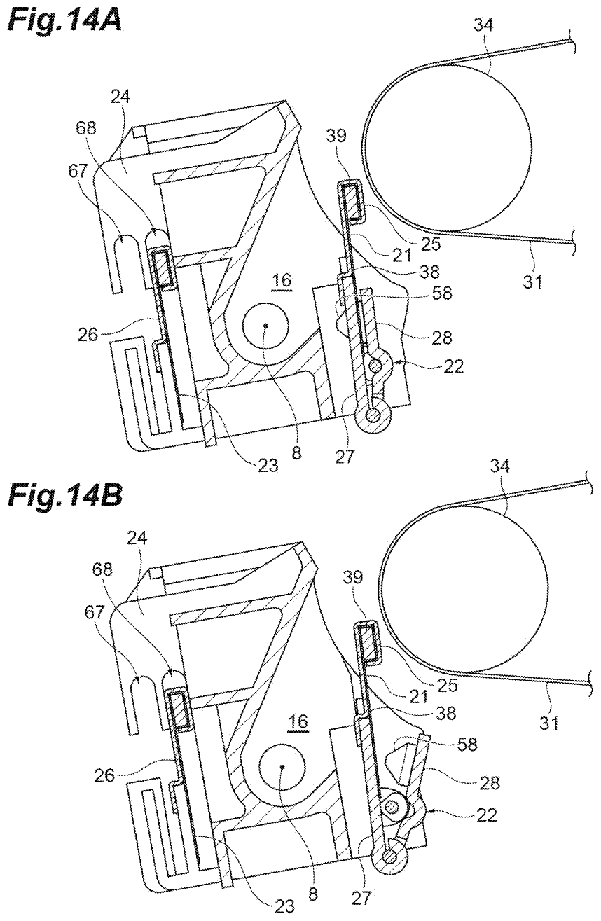

As described above, when the first sliding frame 25 is inserted into the housing 24, the blade 21 supported by the blade holder 22 is inserted into the first sliding frame 25 from the longitudinal end portion of the first sliding frame 25 as shown in FIG. 14A. Accordingly, the sliding portion 39 of the blade 21 is accommodated in the internal space 76 of the first sliding frame 25.

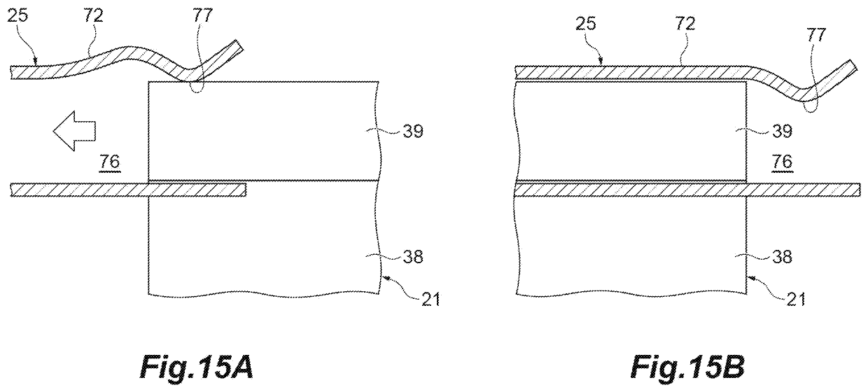

Here, the sliding portion 39 of the blade 21 contacts the protrusion portion 77 of the engagement portion 72 and presses the protrusion portion 77 upward when the blade 21 is inserted from the longitudinal end portion of the first sliding frame 25 as shown in FIG. 15A. Accordingly, the protrusion portion 77 moves upward to form a passage, which allows the blade 21 to enter the cover 71 and to enter the internal space 76 of the first sliding frame 25.

When the first sliding frame 25 is further inserted into the housing 24, and the entire sliding portion 39 of the blade 21 is accommodated in the internal space 76, the protrusion portion 77 returns to the original position by the elastic force of the engagement portion 72 and protrudes toward the passage that allows the blade 21 to enter as shown in FIG. 15B. In this way, the engagement portion 72 is sandwiched between the blade 21 and the longitudinal end portion of the internal space 76, and the blade 21 held by the first sliding frame 25 is restricted from being slipped out from the longitudinal end portion of the cover 71.

Next, as shown in FIG. 14B, the blade holder 22 is opened. The lever 54 is operated to rotate the camshaft 53 in the first direction so that the second member 28 rotates in a direction such that the second member 28 moves away from the first member 27. Accordingly, the second member 28 is disposed at the open position, and the blade 21 can be attached to and detached from the blade holder 22.

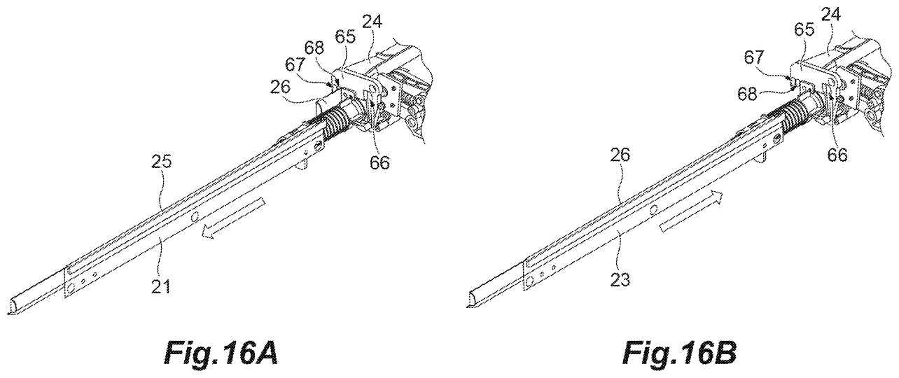

Next, as shown in FIG. 16A, the first sliding frame 25 is retracted in the longitudinal direction, and the first sliding frame 25 is pulled out from the third opening 66 of the housing 24. Since the blade 21 engages with the cover 71 by the engagement portion 72, the blade 21 moves in the longitudinal direction together with the first sliding frame 25 when the first sliding frame 25 is retracted in the longitudinal direction. Then, the blade 21 is pulled out from the third opening 66 of the housing 24 together with the first sliding frame 25.

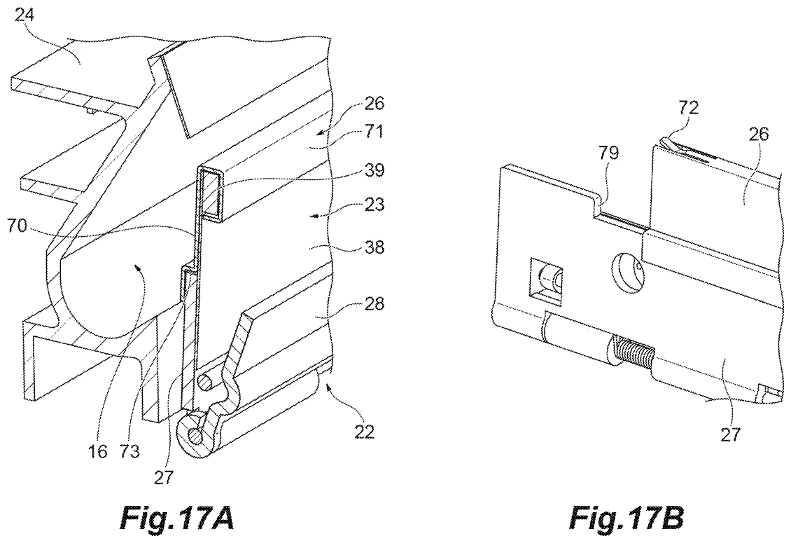

Next, the second sliding frame 26 is pulled out from the second accommodation space 68. The spare blade 23 is held at the second sliding frame 26. Then, as shown in FIG. 16B, the second sliding frame 26 is inserted into the housing 24 through the third opening 66. At this time, as shown in FIG. 17A, the guide rail 73 of the second sliding frame 26 is placed on the upper end surface of the first member 27 of the blade holder 22 and slides along the upper end surface. The second sliding frame 26 is guided in the longitudinal direction by sliding the guide rail 73 along the upper end surface of the first member 27. By guiding the second sliding frame 26, the spare blade 23 may be disposed at an appropriate position inside the blade holder 22 in the up and down direction (i.e., in the axis perpendicular to the longitudinal direction and perpendicular to the plane of the plate portion 38).

As shown in FIG. 17B, a stopper 79, which may be provided in the first member 27 of the blade holder 22, is to limit the slide range of the second sliding frame 26. The stopper 79 may be, for example, a step formed in the upper end surface of the first member 27 and contacts the longitudinal end portion of the second sliding frame 26 to restrict the movement of the second sliding frame 26 in the longitudinal direction when the second sliding frame 26 is inserted to a predetermined position. Since the movement of the second sliding frame 26 in the longitudinal direction is restricted by the stopper 79, the spare blade 23 is disposed at an appropriate position inside the blade holder 22 in the longitudinal direction. Additionally, the first sliding frame 25 is pulled out from the housing 24 with the blade 21 and may be stored in, for example, the second accommodation space 68. When the second member 28 is moved from the open position to the closed position, the lever 54 is operated to rotate the camshaft 53 in a second direction (which is opposite to the first direction

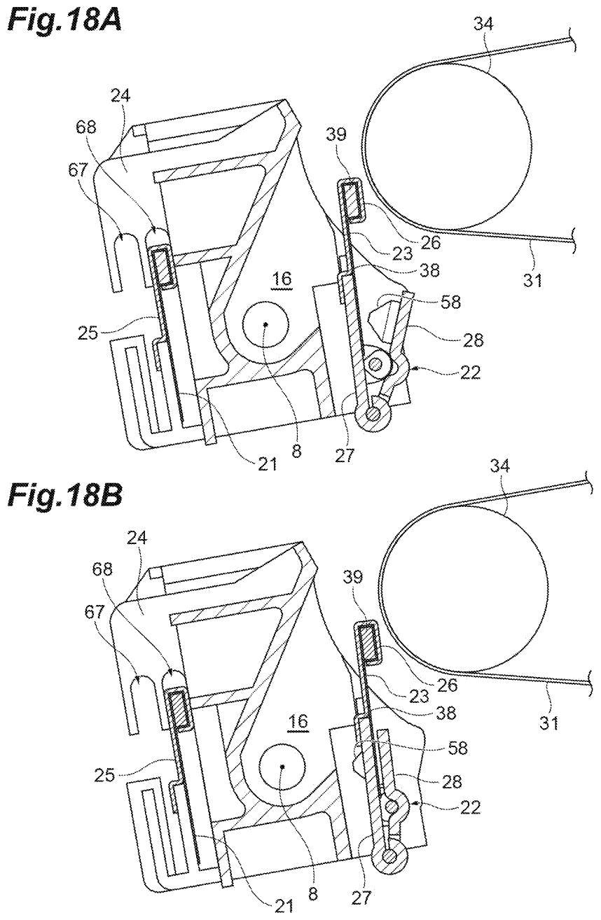

FIG. 18A shows a state in which the second sliding frame 26 is inserted into the housing 24 and the spare blade 23 is disposed inside the blade holder 22. As shown in FIG. 18B, the blade holder 22 is closed. That is, the lever 54 is operated to rotate the camshaft 53 in the second direction (i.e., opposite to the first direction). The second member 28 rotates in a direction such that the second member 28 moves toward the first member 27. Accordingly, the second member 28 is disposed at the closed position, and the pin 58 of the second member 28 is inserted into the second opening 63 of the first member 27 through the first opening 61 of the spare blade 23. As a result, the spare blade 23 is fixed in the longitudinal direction of the blade holder 22. At the closed position, the second member 28 is urged toward the first member 27 by the spring 46, and the second member 28 is locked.

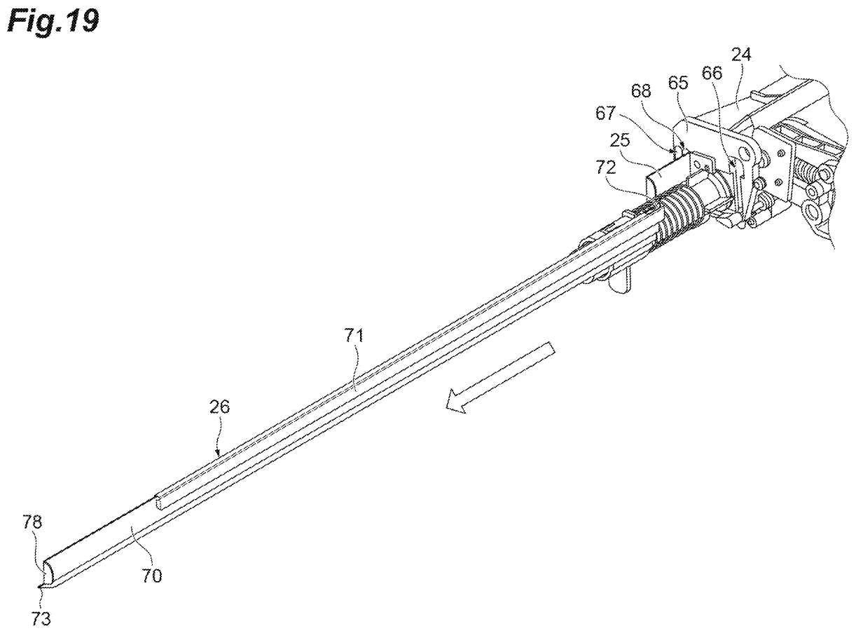

As shown in FIG. 19, the second sliding frame 26 is pulled out from the third opening 66 of the housing 24 in the longitudinal direction. Here, since the blade holder 22 is at the closed position, and the spare blade 23 is fixed to the blade holder 22, the spare blade 23 is slipped out from the longitudinal end portion of the second sliding frame 26 and is left inside the blade holder 22 when the second sliding frame 26 is pulled out from the housing 24. More specifically, when the second sliding frame 26 is pulled out from the housing 24, the sliding portion 39 of the blade 21 contacts the protrusion portion 77 of the engagement portion 72 of the second sliding frame 26 to press the protrusion portion 77 upward. Accordingly, the protrusion portion 77 moves upward, and the spare blade 23 is separated from the cover 71 of the second sliding frame 26. The second sliding frame 26 pulled out from the third opening 66 may be stored in, for example, the first accommodation space 67.

As described above, the used blade 21 is replaced with the spare blade 23. In an image forming apparatus, a blade supporting device is disassembled to replace a blade (e.g., replacing the entire blade supporting device rather than replacing individual blades). In the blade supporting device 100, since the blade 21 can be easily replaced without disassembling and/or replacing the blade supporting device 100, the maintenance cost of the image forming apparatus 1 can be greatly reduced. Further, the lifespan of the blade supporting device 100 is generally longer than the lifespan of the blade 21. Since the blade supporting device 100 can be used continuously (i.e., without replacing the blade supporting device 100) by replacing the blade 21, the lifespan of the blade supporting device 100 can be extended.

It should be understood that aspects, advantages, and features described herein are not necessarily achieved or included in any one particular example. Indeed, while various examples have been described and shown herein, it should be apparent that other examples may be possible in terms of, for example, arrangement, substitution, combination, and/or configuration. All corrections and modifications included in the scope of the subject matter disclosed herein are claimed.

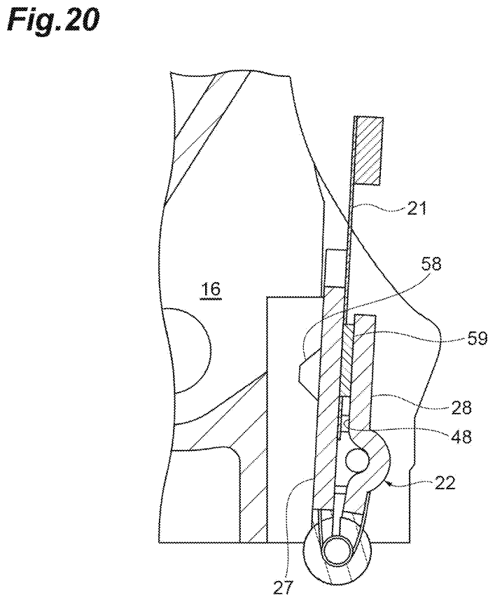

For example, in the above-described example, the second member 28 is urged against the first member 27 by the spring 46 so that the second member 28 is kept at the closed position. However, in order to keep the second member 28 at the closed position, for example, as shown in FIG. 20, a magnet 59 may be provided in the inner surface 48 of the second member 28 as a locking device when the urging force of the spring 46 is not sufficient. The second member 28 can be locked by pulling the second member 28 toward the first member 27 by the magnetic force of the magnet 59.

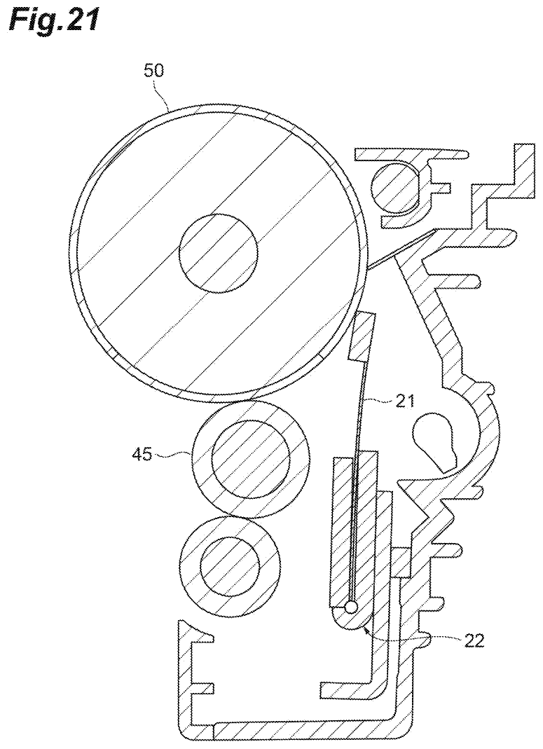

The blade supporting device 100 is to remove the toner remaining on the intermediate transfer belt 31, but the blade supporting device 100 may remove the toner from the conveying body. For example, as shown in FIG. 21, the blade supporting device 100 may be disposed adjacent to the photoreceptor 40, and the blade 21 supported by the blade holder 22 may collect the toner remaining on the photoreceptor 40 after the toner image is transferred to the intermediate transfer belt 31.

Further, the blade supporting device 100 may be used as a layer thickness regulating device to limit the thickness of the toner carried on the outer peripheral surface of the developing roller 45. When the blade supporting device 100 is used as the layer thickness regulating device, the blade 21 is disposed adjacent to the outer peripheral surface of the developing roller 45 in order to form a layer of the toner having an appropriate thickness on the developing roller 45. When the blade supporting device 100 is used as the layer thickness regulating device, the maintenance cost of the layer thickness regulating device can be reduced by replacing the blade 21.

In the above-described example, the first sliding frame 25 inserted into the housing 24 may be retracted in the longitudinal direction, and the blade 21 held by the first sliding frame 25 may be pulled out from an opening of the housing 24. When the blade 21 is replaced, the first sliding frame 25 may be omitted. For example, the blade 21 may be separated by pinching the blade while the second member 28 of the blade holder 22 is at the open position. Further, the blade supporting device 100 may be to pull out the blade 21 from the housing 24 such that the blade holder 22 is slidable with respect to the housing 24, and the blade holder 22 slides through the third opening 66 in the longitudinal direction.

Various examples disclosed herein can be combined without contradiction.

1. A blade supporting device comprising:
a housing;
a blade holder supported by the housing, the blade holder comprising:
a first member to support a blade; and
a second member movable between a closed position and an open position, wherein the blade is sandwiched between the first member and the second member at the closed position, and the second member is separated from the first member at the open position; and
a locking device to lock the second member and keep the position of the blade with respect to the first member.

2. The blade supporting device of claim 1, wherein the locking device is to urge the second member with respect to the first member.

3. The blade supporting device of claim 2,
wherein the blade holder comprises a hinge to connect the first member and the second member such that the second member is rotatable; and
wherein the locking device comprises a spring connected to the hinge to urge the second member with respect to the first member.

4. The blade supporting device of claim 3, further comprising:
a cam rotatable between the first member and the second member, the cam to rotate the second member about the hinge.

5. The blade supporting device of claim 4, further comprising:
a lever connected to the cam through a camshaft to rotate the cam.

6. The blade supporting device of claim 1,
wherein the blade comprises a first opening, and the first member comprises a second opening; and
wherein the second member comprises a pin, the pin to be inserted into the second opening through the first opening and to fix the blade with respect to the first member when the second member is at the closed position.

7. The blade supporting device of claim 1, wherein the housing comprises a longitudinal end portion and a third opening.

8. The blade supporting device of claim 7, further comprising:
a sliding frame to be inserted into the housing through the third opening, the sliding frame to engage with the blade and pull out the blade from the housing.

9. The blade supporting device of claim 8, the sliding frame comprising: a cover to accommodate at least a part of the blade; and
an engagement portion disposed at a longitudinal end portion of the cover to engage the blade with the cover.

10. The blade supporting device according to claim 9, the engagement portion comprising a protrusion portion, wherein:
the protrusion portion is to move when the blade is inserted into the cover from the longitudinal end portion of the cover; and
the protrusion portion is to prevent the blade from being slipped out from the longitudinal end portion of the cover when the blade is accommodated in the cover.

11. The blade supporting device of claim 1, wherein the housing is disposed adjacent to the blade holder, the housing comprising an accommodation space to accommodate a spare blade.

12. An image forming apparatus comprising:
a conveying body; and
a blade supporting device disposed adjacent to the conveying body, the blade supporting device comprising:
a housing;
a blade holder supported by the housing, the blade holder comprising:
a first member to support a blade; and
a second member movable between a closed position and an open position, wherein the blade is sandwiched between the first member and the second member at the closed position, and the second member is separated from the first member at the open position; and
a locking device to lock the second member to keep the position of the blade with respect to the first member.

13. The image forming apparatus of claim 12,
wherein the blade holder comprises a hinge to connect the first member and the second member such that the second member is rotatable; and
wherein the locking device comprises a spring connected to the hinge to urge the second member with respect to the first member.

14. The image forming apparatus of claim 12,
wherein the blade comprises a first opening, and the first member comprises a second opening; and
wherein the second member comprises a pin, the pin to be inserted into the second opening through the first opening and to fix the blade with respect to the first member when the second member is at the closed position.

15. A blade supporting device comprising:
a housing; and
a blade holder supported by the housing, the blade holder comprising:
a first member to support a blade; and
a second member connected to the first member, the second member movable between a closed position and an open position, wherein the blade is fixed to the blade holder at the closed position, and the blade is released from the blade holder at the open position.
